(19) United States
(12) Patent Application Publication
(10) Pub. No.: US 2006/0064644 A1
(43) Pub. Date: Mar. 23, 2006

(54) Short-term filmmaking event administered over an electronic communication network

(76) Inventor: Jin Woo Joo, San Francisco, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/231,604

(22) Filed: Sep. 20, 2005

Related U.S. Application Data
(60) Provisional application No. 60/611,652, filed on Sep. 20, 2004.

(51) Int. Cl. H04N 7/173; G06F 17/00; G06F 3/00; G06F 9/00

(52) U.S. Cl. 715/751; 725/114; 725/116

(57) ABSTRACT

Methods and systems for conducting short-tem filmmaking events are disclosed, in which a set of rules is provided to a plurality of entities, each entity comprising an individual or a team of individuals. Some of the entities can be located in different cities, states or countries. Movies created by the entities in conformity with the rules are received over an electronic communications network in a specified period of time. The movies can be distributed or presented over the electronic network and/or screened at local venues. In some embodiments the system permits audience members to submit quality ratings for one or more of the presented films through the electronic communications network. In some embodiments an automated system is configured to permit users to electronically search a storage of the films by textual queries for film content, and the system is configured to electronically transmit matching or related films to such users. In some embodiments footage is obtained of at least one of the entities attempting to create a film conforming to the film rules, and a film is created interweaving said footage with selected portions of the films received from the entities. In some embodiments the entities are provided access to filmmaking resources through the electronic communication network, the resources comprising one or more of video clips available for insertion into a film, music clips available for use in a film, filmmaking tips and guidelines, a web-based subtitle creation utility, and contact information for individuals available for joining and assisting one of the entities in creating a film.

### CROSS-REFERENCE TO RELATED APPLICATIONS

This application claims priority to U.S. Provisional Application No. 60/611,652, filed Sep. 20, 2004, the entire disclosure of which is incorporated by reference herein.

### BACKGROUND OF THE INVENTION

1. Field of the Invention

The present invention relates generally to filmmaking and specifically to filmmaking events and supporting infrastructure in which participants generate multimedia content in a limited time.

2. Description of the Related Art

A film festival is a moviemaking event in which creators submit motion pictures to be screened to an audience. One example is the Tribeca Film Festival. Traditional film festivals accept movie submissions for public exhibition and typically have a submission window with a deadline on a date after the opening call for entries. These film festivals normally require submission of movies in a physical format. For example, film festivals often require submission on DVD, VHS tape, MiniDV tape, or actual film. Public screenings occur a relatively long time (e.g., months) after the date of submission. In a typical film festival, audience interaction in rating and providing feedback, and the audience's ability to influence the viewing experience for subsequent audience members, is non-existent or highly constrained.

The availability of advanced digital moviemaking technology has made possible short-term film festivals and competitions, in which moviemakers are given a short (e.g., 24 hours) time period within which to create and submit a movie. One known short-term film festival is “48 Hours,” in which contestants are given 48 hours to create and submit their movies. These short-term moviemaking events function much like a traditional film festival. Screenings occur in one location at a time on different dates. Participants ordinarily must be physically present to submit their movie by the deadline. Traditional infrastructure limits the volume of entries allowed. Viewer feedback is relatively limited and usually informal. The audience is normally unable to select or control which movies are screened. Submissions are typically made on physical media such as a tape or DVD. Submitted movies are typically publicly screened on a date long after the date of the submission deadline.

### SUMMARY OF THE INVENTION

In one aspect, the present invention provides a method of conducting a filmmaking event. According to the method, a set of rules is provided to a plurality of entities, each entity comprising an individual or a team of individuals. Some of the entities are located in different cities, states or countries. Movies created by the entities in conformity with the rules are received over an electronic network in a specified period of time. The movies are distributed over the electronic network.

In another aspect, the present invention provides a method of conducting a filmmaking event. The method includes communicating a start time and an end time to a plurality of geographically dispersed filmmaking entities, the end time being no later than 48 hours after the start time. Each of the entities comprises an individual or a team of individuals. A set of film rules is given at or after the start time to each of the entities. Films are received before the end time from at least some of the entities, wherein at least some of the received films meet all of the film rules. Some of the received films are presented over an electronic communications network to a plurality of geographically dispersed audience members.

In another aspect, the present invention provides a method of conducting a filmmaking event, including communicating a start time and an end time to a set of filmmaking entities, the end time being less than 48 hours after the start time. Each of the entities comprises an individual or a team of individuals. A set of film rules is given at or after the start time to each of the entities. Films are received before the end time from at least some of the entities, wherein at least some of the received films meet all of the film rules. Selected ones of the received films are presented to audience members, and quality ratings for one or more of the presented films are received through an electronic communications network from the audience members.

In yet another aspect, the present invention provides a method of conducting a filmmaking event, including communicating a start time and an end time to a set of filmmaking entities, the end time being no later than 48 hours after the start time. Each of the entities comprises an individual or a team of individuals. A set of film rules is given at or after the start time to each of the entities. Films are received before the end time from at least some of the entities, wherein at least some of the received films meet all of the film rules. Selected ones of the received films are stored in an electronic storage, access is provided to the selected ones of the received films over an electronic communication network. The method includes providing an automated system configured to (1) receive a textual search query through the electronic network from a remotely located individual; (2) search the storage for films having content that relates to the search query; and (3) if one or more films are found that relate to the search query, transmit said one or more related films or information regarding said related films to the remotely located individual through the electronic network.

In yet another aspect, the present invention provides a method of conducting a filmmaking event, including communicating a start time and an end time to a set of filmmaking entities, the end time being no more than 48 hours after the start time. Each of the entities comprises an individual or a team of individuals. A set of film rules is given at or after the start time to each of the entities. Footage is obtained of at least one of the entities as said at least one entity attempts to create a film conforming to the film rules. Films are received before the end time from at least some of the entities, wherein at least some of the received films meet all of the film rules. A film is created interweaving said footage with selected portions of the films received from the entities.

In still another aspect, the present invention provides a method of conducting a global filmmaking event, including communicating a start time and an end time to a set of filmmaking entities, the end time being no more than 48 hours after the start time. Each of the entities comprises an individual or a team of individuals. A set of film rules is given at or after the start time to each of the entities. The entities are provided access to filmmaking resources through an electronic communication network. The filmmaking resources comprise one or more of video clips available for insertion into a film, music clips available for use in a film, filmmaking tips and guidelines, a web-based subtitle creation utility, and contact information for individuals available for joining and assisting one of the entities in creating a film. Films are received before the end time from at least some of the entities, wherein at least some of the received films meet all of the film rules.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is a flow diagram illustrating a process of conducting a short-term filmmaking event in accordance with an embodiment of the present invention.

FIG. 2 is a flow diagram illustrating a simultaneous transmission of film ingredients to a variety of participants in different time zones, according to an embodiment of the present invention.

FIG. 3 is a flow diagram illustrating a time-staggered transmission of film ingredients to a variety of participants in different time zones, according to an embodiment of the present invention.

FIG. 4 is a flow diagram illustrating a transmission of different sets of film ingredients to participants in different time zones, according to an embodiment of the present invention.

FIG. 5 is an illustration of how participants in a geographic area can collectivize to create a new local filmmaking event that coincides with a plurality of planned events for a specific event date.

FIG. 6 is an illustration of how individual participants can use the event infrastructure of an embodiment of the invention to join existing teams or form new teams.

FIG. 7 is an illustration of a computer-enabled interface configured to allow a user to add subtitles to video information, in accordance with an embodiment of the invention.

FIG. 8 is a chart describing functions and tools, without limitation, that are facilitated and provided by embodiments of the present invention.

### DETAILED DESCRIPTION OF THE PREFERRED EMBODIMENT

The current invention enables a concurrent moviemaking and distribution event that can be administered globally or in selected regions. This system enables controlled delivery of prescribed elements that movie production teams around the world can include in movies they make, including movies made in a short timeframe. The system then allows rapid global distribution of movies made by these teams. Such movies can be screened globally through a variety of media, including the Internet. It will be understood that aspects described herein with reference to the Internet can be implemented over alternative or additional electronic communication networks. The invention allows for broad-based and concurrent global participation. An announcement of requirements to be included in each movie may start the process. Teams of moviemakers, actors, and crew make movies that conform to these requirements before the submission deadline. Movies can be distributed globally and screened soon after they are submitted. The brevity and distributed nature of the event enabled by this system differentiates the creation and distribution experience of moviemakers and audiences.

Embodiments of the invention allow participants to make and submit movies from anywhere in the world. They also allow the audience to view the finished movies from anywhere in the world on the same day or relatively soon after the movies are made. Consequently, movies can be made, submitted, distributed, rated, and judged all within a short time period. The immediacy of a short time frame coupled with the global collective experience of different moviemaking teams is an advantageous feature of this invention.

The present invention relates to an event and supporting infrastructure in which participants generate multimedia content in a competitive time-pressured format. In an embodiment, the multimedia content (short films in a preferred embodiment) conform to requirements announced at the outset of the competition. The content produced by participants is distributed through television, Internet, DVD subscription and public in-person screenings. The embodiment allows teams to compete and demonstrate their creativity in short-film making. Further, it allows a broad-based or global audience to view and rate movies using automated systems available on media such as the World-Wide Web. In this manner the embodiment provides a unique end-to-end entertainment “channel” whereby creativity at a grassroots level may be made available to a diverse and geographically distributed audience quickly.

While the invention is described herein in the context of a short-filmmaking competition, it can be applied to any form of multimedia content. For example, a music or song creation competition can be created that utilizes the same general format and technological infrastructure. In some variations, participants compete to create musical compositions rather than or in addition to short films.

The current invention allows a break from traditional moviemaking and distribution conventions. Specifically, moviemaking and screening contained within a relatively short time such as the waking hours of one day gives both moviemakers and audience a unique experience. Further, the globally distributed nature of participation and distribution expands the talent pool, and opens up opportunities for a paradigm shift in entertainment and cross-cultural communication.

As used herein, the term “film festival” does not suggest that movies are recorded exclusively on traditional film (e.g., silver-halide suspended in gelatin). Any motion picture recording medium can record the content exhibited in a Film Festival. Therefore, the terms Film Festival and Movie Festival are used interchangeably herein. The term “film” refers to any medium containing motion picture data, such as videotape, digital video files, conventional movie film, and the like.

By combining cutting-edge technology, including Internet-based submission and distribution technology, with a unique short-term filmmaking format, the invention facilitates a globally distributed short-filmmaking competition that includes concurrent global participation, distribution, and screening.

As mentioned, described herein are systems and methods for conducting a globally distributed short-term moviemaking event. By “short-term,” it is meant that the start time and end time of the filmmaking portion of the event are temporally spaced apart by a relatively short time, such as one month, three weeks, two weeks, 7 days (168 hours), 6 days (144 hours), 5 days (120 hours), 4 days (96 hours), 3 days (72 hours), 2 days (48 hours), 1 day (24 hours), 18 hours, 16 hours, 14 hours, 12 hours, 10 hours, 8 hours, 6 hours, or 4 hours, 3 hours, 2 hours, or even 1 hour. An embodiment allows participants to make and submit movies from anywhere in the world according to the rules of the event. An embodiment allows the audience to view the finished movies from anywhere in the world upon submission of movies. Movies can be screened globally very shortly after they are submitted.

The systems and methods of the present invention include a variety of advantageous features. Ingredients to be included in the films (or in the songs) can be distributed through conventional or electronic means to contestants situated virtually anywhere globally. Movies can be made anywhere in the world, adding to the cultural and conceptual variety to be found in the submissions. Movies are made within a short time frame, such as during the waking hours of the day. Movies can be screened globally shortly after submission, and such screenings can be undertaken in a variety of venues, such as movie-houses, bars, restaurants or people's homes. Movies can be submitted from anywhere in the world using a variety of techniques such as uploading on the Internet, delivering media (such as a DVD) via messenger services or any combination thereof. Movies can be distributed through a network and screened globally shortly after submission.

The systems and methods of the present invention can employ a variety of different combinations of technologies. Advances in digital moviemaking tools and improved motion picture compression algorithms make it possible to maintain movie quality while keeping video and audio file sizes small (such as Sorensen 3, Mpeg 3 and 4, and H.264). Global reach is facilitated by increases in the bandwidth of available Internet connections (e.g., DSL, cable modems, T1, and greater levels of backbone connectivity at the network operations centers).

People are increasingly using widely available digital movie making tools to make movies less expensively and in less time. Widely available digital video cameras allow easy download of movie content to personal computers and movie editing software that gives ordinary consumers the ability to manipulate and edit this footage. Examples include Apple Final Cut Pro, Apple iMovie, Adobe Premiere, or Windows Movie Maker. Many more editing tools are available to the average consumer.

Other tools, such as animation, special effects, compositing, and 3-D animation tools have also become widely available. Examples include Adobe AfterEffects, Apple Shake, Macromedia Flash, Alias/Wavefront Maya, Discreet 3ds Max. These tools give people the ability to tell stories and create visual effects from home computers.

In the music domain, tools such as Apple GarageBand make it easy to produce a relatively high-quality music track in a relatively short period of time. This type of technology can facilitate music-related embodiments of the invention.

Transfer of quality video through the Internet is bandwidth intensive. The bandwidth required for transfer of motion video in a reasonable timeframe is much higher than a short text document or static image. Fortunately, the Internet bandwidth available to the average consumer has increased dramatically. This availability of bandwidth makes it possible to transfer larger files in less time. Examples of this widely available technology include consumer Cable and DSL Internet subscriptions.

Improvements in motion picture compression technology has made it possible to create high quality video files with ever smaller file sizes. This makes it possible to transmit high quality video clips over the Internet bandwidth available to the average consumer. Quality of video picture is especially important when screening in larger formats. Combined with the higher Internet bandwidth available to the average consumer, it is now possible to transfer higher quality movies in a reasonable time period to screen movies in a large format. Current compression technologies facilitate faster upload and distribution of entries.

Overview

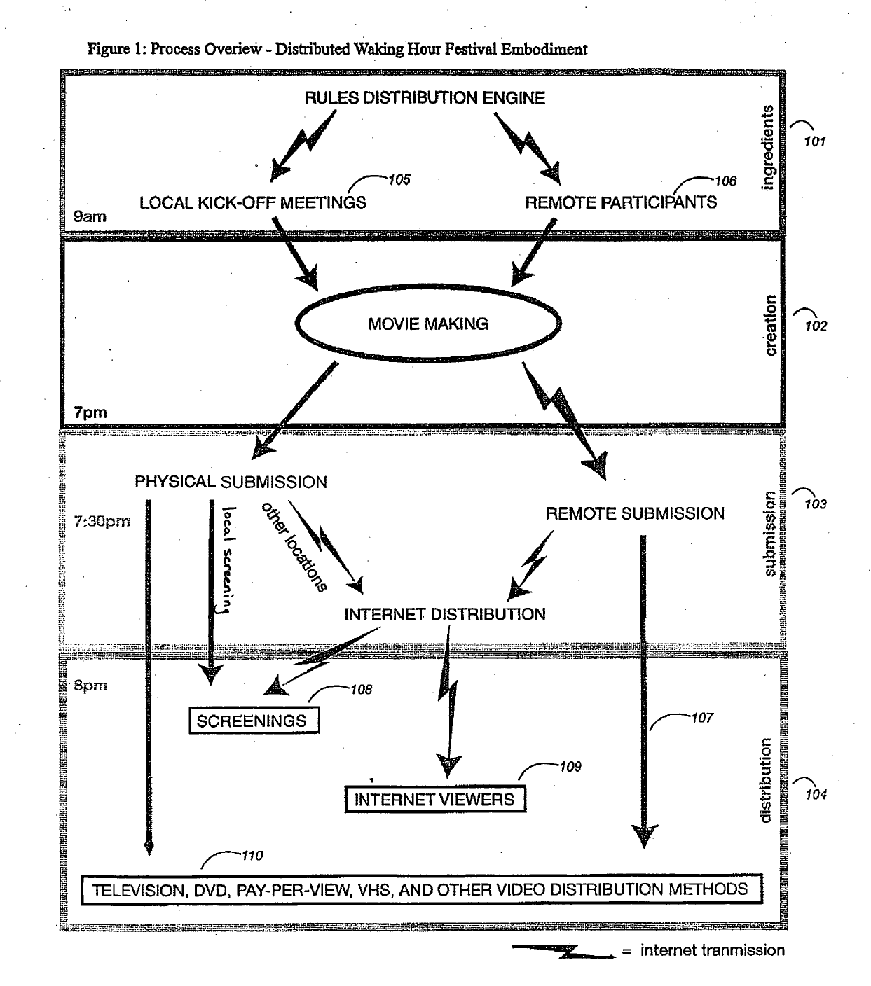

The figures illustrate a system and method of conducting a short-term filmmaking event or competition. However, it will be appreciated that the invention can focus on music content. FIG. 1 illustrates a process of the invention according to one embodiment. The illustrated process preferably occurs within a waking hour film festival, in which the movies are created and screened the same day. On the morning of the event, required elements (also referred to herein as “ingredients”) and constraints are distributed 101 to participating teams. Teams spend that day creating 102 movies that include those elements and conform to those constraints. Teams submit 103 final movies that are screened 104 (e.g., locally, regionally, or globally) at the end of that same day. The compact timeframe and immediacy of moviemaking and screening synergize to create an action-packed and exhilarating experience.

The time of the event is a significant aspect of the invention. Some embodiments may take 24 hours or multiple days to complete the event. Yet other embodiments take mere hours to run the event and distribute resulting movies.

In one embodiment, camera crews follow some or all of the participating teams to capture footage reflecting the creative process that goes into making a short-film. Ultimately, this footage may be incorporated into a documentary-type video, which could include interwoven portions of documentary footage of the teams making their short-films, along with portions conveying the actual short-films generated by the teams. These compilations of documentary footage and the shorts themselves could be distributed on any of a variety of different types of media, including the Internet, DVD (or video) and television.

Participant Base

The participant base of the invention can be local and/or remote. The format and infrastructure of embodiments may allow participation of people representing a wide range of skill levels. With continued reference to FIG. 1, in a local participation mode can involve local participants that physically attend a kick-off meeting 105 (where they are instructed as to the required cinematic ingredients for their short films) and physically submit their final movie to event officials. These participants are located in a region where an organized kick-off meeting, submission location, and screening are located. Multiple local events may take place concurrently around the world.

On the other hand, remote participants 106 can receive information, submit, and watch final movies through the Internet. Often these participants are located physically far away from each other and from event administrators. In other variations, participants can participate in hybrid modes. Participants can receive kick-off information remotely, but submit and screen at a locally organized location. Other participants will attend a physical kick-off location and submit their movies remotely.

Some embodiments of the current invention also include valuable resources for participants. These include moviemaking resources such as content archives (such as for music), clip art and movie clips. Further, the system could provide tips for content licensing, online forums and bulletin boards, the ability to post to a messaging system, moviemaker and actor profiles, resumes, and headshots. Moviemakers and actors will also be able to post creative works unrelated to the current invention to share with viewers interested in seeing more work by a favored artist. These resources help moviemakers and actors find teams and members, acquire information, plan for the event, and acquire ideas and public domain or limited use licensed content such as music for their submissions.

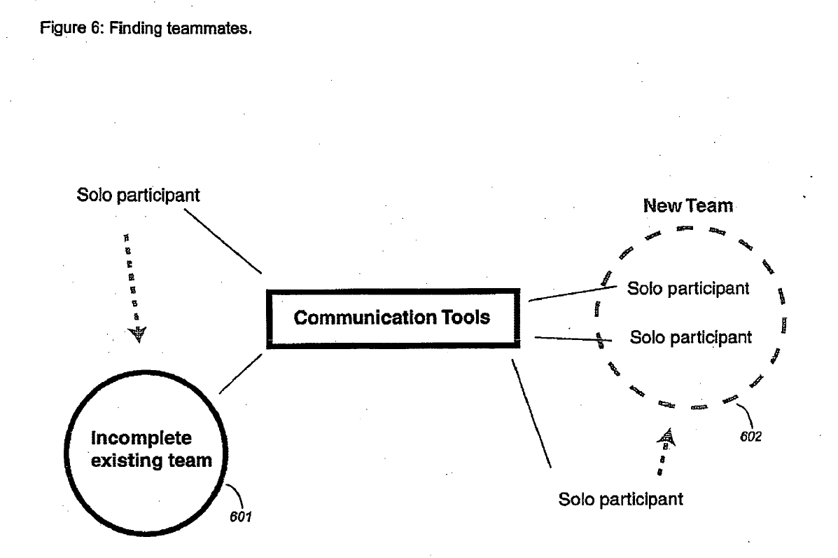

With reference to FIG. 6, systems and methods of the invention allow individuals without a team (solo participants) to find teammates to form a new team 602 or join an existing team 601 within the community network of event participants. The current invention also allows existing teams to find new members.

Prior to the event, both individuals and teams may use the communication tools available on the community-based portal to find new teammates. These tools may include an online forum or bulletin board with a section specifically devoted to looking for teammates. Available tools also include an Internet accessible database of individuals and team profiles searchable by location, skill-set, and preferences. An individual or team looking for teammates may use this database to find or evaluate potential teammates and contact them to organize team membership. Thus, solo participants can create new teams with other solo participants or join incomplete existing teams searching for new members.

In an embodiment, individuals or teams may also find teammates at the kick-off meeting at the start of the event. An announcement at this kick-off meeting asks individuals and teams looking for teammates to identify themselves. Interested parties may then confer and self-organize into new teams or join existing teams. It is possible that a team be comprised of members who have never met prior to the event.

With reference to FIG. 5, the current invention allows community-initiated and organized local events to join the network of existing local events for any event date. Many independent individuals, groups, and organizations may organize a local event in their respective area. For example, a remote team or teams may initiate a local event in their area by collectivizing a number of teams that would otherwise participate remotely or by recruiting new participants in their area 501. These collectivized teams or individuals can thereby create a new local event linked to the system's network of existing events for an event date. Local organizations or individuals involved in a location's filmmaking community may initiate a new local event. Examples of this kind of organization include local Film focused non-profit entities such as the Film Arts Foundation in San Francisco (http://www.filmarts.org) or film festivals like the Mill Valley Film Festival (http://www.mvff.com). Screening venues such as movie theatres, lounges, cafes, and bars may initiate and organize a new local event.

In one embodiment, organizers follow the following protocol:
Sign-up a new local event using a form available on the online system of the invention.
Download online directions for planning and running a local event.
Establish a venue for screening and a location for a kick-off meeting.
Publicize the new event using the communication tools available online and other publicity channels.
Resolve questions or concerns through communications with central event administrators or other local event organizers.
Run the short filmmaking event in accordance with guidelines available for event organizers online.

Subsequently, this self-organized, community-based event location may include a local kick-off meeting, physical submission location, and group screening. The screening may be open to the public. Analogous event locations worldwide may exchange movies through the Internet with other event locations worldwide for the screening.

The current invention facilitates this self-organization of community initiated event locations by publicizing the new event location on the events calendar (available online at a central website.), announcing such event locations in newsletters (email and physical), and providing communications and networking tools for prospective teams such as a central online bulletin board and forum.

In one embodiment of the current invention, a dedicated section of the online system may allow authorized event organizers to view event-planning guidelines and communicate with fellow organizers in other locations.

Distribution of Rules and Requirements

In an embodiment, participants commence moviemaking upon receiving a specific set of requirements (sometimes called “ingredients”). For example, in one embodiment, a team of participants may receive instructions to make a 3-minute movie that includes the following ingredients:
Two lovers reunite after years apart.
A car breaks down.
An orange peel.

Participants must incorporate these requirements into the movies they make that day. In addition, the requirements distributed at the beginning of the event detail other guidelines such as movie duration, submission deadline, submission procedures, and screening procedures. In a preferred embodiment, distribution of ingredients is global.

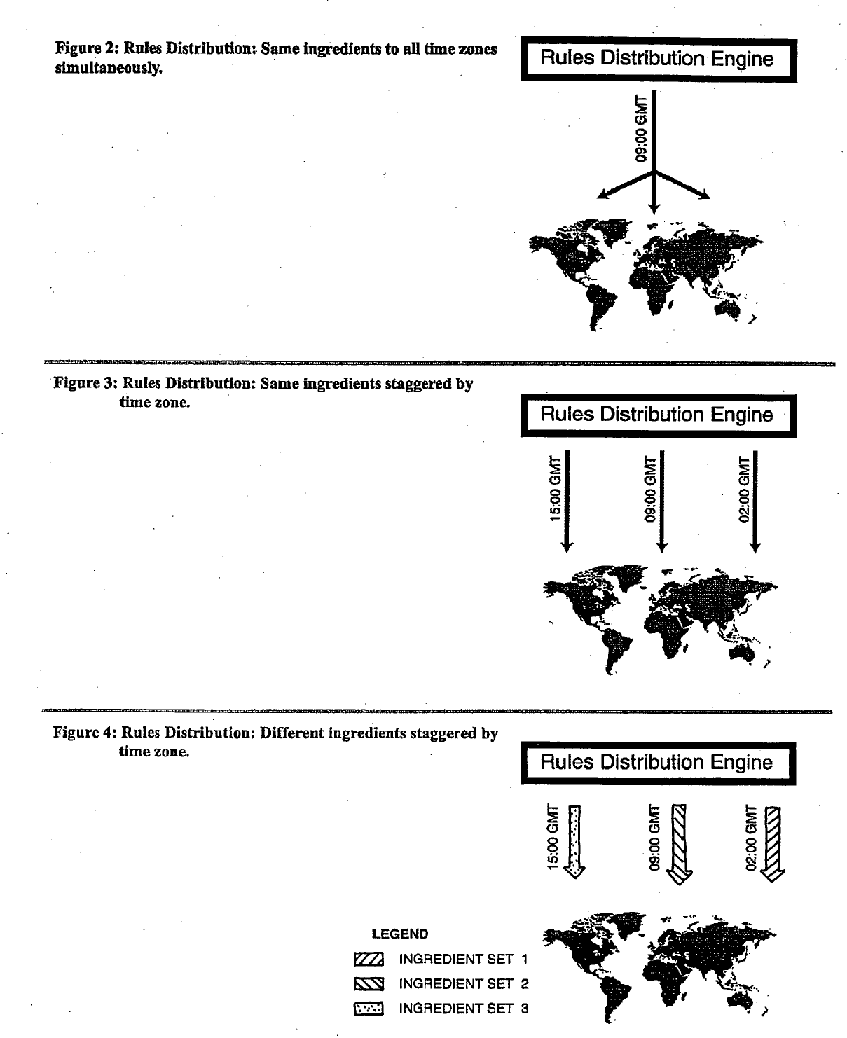

With reference to FIGS. 2-4, embodiments of the invention can include a Configurable Rules Distribution Engine (“rules engine”) that distributes special requirements and constraints to participants at the start of every event (rules). Some rules, such as prescribed elements required in each movie (ingredients) are announced only at the start of the event. While this rules engine delivers rules directly to remote participants, it can deliver rules to officials to announce at local kick-off meetings. Moviemaking begins upon the arrival of rules from a rules engine.

A preferred rules engine is configurable in a number of ways, including the time of distribution, content of rules, and modes of transmission. While some configurations affect all participants, other configurations affect different groups or even individual participants.

The rules engine can be configured to deliver rules to each participant at any time. In one embodiment, an event may start at a specific time during the morning in each time zone. The same set of requirements and constraints can be distributed to each time zone in a staggered manner. For example, as shown in FIG. 3, the rules engine would deliver the rules to the participants at 9 AM in each participant's local time zone. In another embodiment, illustrated in FIG. 2, events may start in all time zones simultaneously, so the rules engine could be configured to send rules (including film requirements, constraints, and ingredients) to all participants around the world at the same time. Still other events may require individual participants to receive rules at customized times. Various embodiments of the rules distribution engine can accommodate all these scenarios.

In one embodiment a competition comprises three short-filmmaking events with different ingredients. The timing of distribution of ingredients for each of the events is different (displaced by eight hours), but for each event, global distribution is simultaneous. By combining three events whose launch times are staggered, on the whole, no team is disadvantaged either as to the time of day (which impacts the availability of natural lighting), nor is there a concern that teams might be disadvantaged because some contestants communicate ingredients to competitors in other parts of the world prior to the official distribution in that time zone (because distribution for each event is simultaneous).

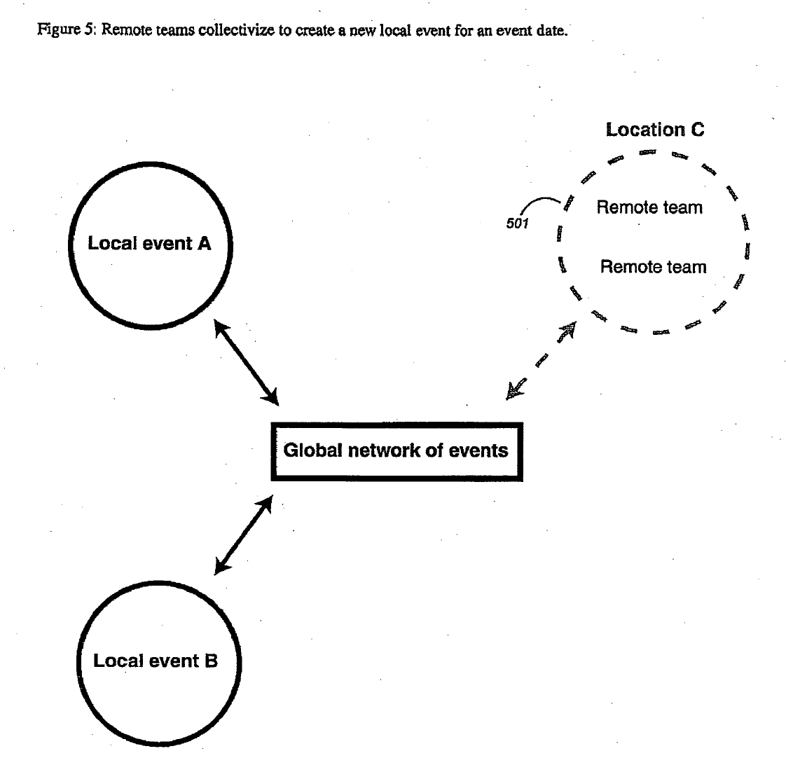

Regarding rule content, the rules can be tailored to each participant or groups of participants separately. In one embodiment, illustrated in FIG. 4, participants in each time zone may receive different ingredients, requirements, and constraints staggered by time zone. For example, while movies from Asia may require a shot of falling leaves, movies from Europe may require a shot of someone biting a peach. All of the participants can receive their film ingredients at a given time in their time zone, e.g., 9 AM local time. Other scenarios include different rules sent to each participant. For example, each participant may receive random ingredients from a large pool of ingredients. Of course, the rules engine may be configured to send the same rules to all participants.

Rules can reach participants through a number of modes. They may reach participants through electronic communication channels, such as the Internet, conventional telephone networks, cellular networks, private networks, etc. This includes email messages to participants, text messages to participants' cell phones or handheld devices, or an Internet URL with special logon and password. In other embodiments, the rules can be broadcast in radio or television signals. Other participants receive rules through in-person announcements at kick-off meetings held globally.

Moviemaking

In embodiments, teams make movies by going through an expedited version of the steps required to make a full-length feature film. These steps may include brainstorming and writing a screenplay, rehearsing scenes, filming scenes, production and post-production.

In some embodiments, a documentary film crew may follow the participating teams to capture the various steps that go into making the short film. Eventually this footage could be compiled into a video narrative that includes footage of the participants' moviemaking activities interwoven with portions of the short-films produced by the teams. In some embodiments, documentary footage is broadcast live or shortly after collected during the event.

The current invention can include a variety of collaborative multi-user and single-user movie and audio editing tools. These tools can allow multimedia editors to edit and process video and audio, collaborate remotely with people around the world in real-time or near real-time, and re-import these editing decisions into traditional single-user nonlinear editing and effects software.

An online movie and audio editor can allow users to accomplish tasks currently associated with single-user nonlinear editing software that resides on a single computer. This online editing application will allow editing from a single location as well as remote collaboration between users from geographically distant locations in real-time or near real-time. This online editor can effectively allow users to form teams for short term filmmaking competition from members in different locations. It also allows distant collaboration between creators on other moviemaking, multimedia, and audio projects.

A fundamental task of movie editing is creating a final movie from serialized fragments of raw footage. Nonlinear editing software allows a user to specify a new in-point and out-point from a raw footage clip and place a representation of that fragment on a movie timeline. The editing software creates an edit decision list by tracking the original clip, the time codes for the new user-specified in-point and out-point, and that fragment's position on the final timeline. The final movie is a rendering of serialized clip fragments based on this edit decision list, a virtual representation of the final movie.

Editing and effects software may also allow users to apply effects to the movie or audio by processing the visual frames or audio in specific ways. In this case, the software uses special algorithms to alter frames of the movies or the audio signal to create these effects. Users specify these effects through the software's interface, and the software adds these directives to the edit decision list to process upon rendering of the movie or audio.

Embodiments of the online film and audio editing application can accomplish the same tasks as a single-user, single computer, nonlinear editing software application in a way that also allows collaboration between multiple users geographically distant from one another.

The current invention allows the user to serialize user-defined fragments of raw footage to create a version of the final movie through a web browser.

The user works with a set of compressed raw footage clips that represent the original raw footage clips. The system indexes the compressed version of the raw footage with the original footage, and the compressed versions match the original clips frame by frame. The system may automate the compression, indexing, and upload of these original clips for use in a distributed environment, whereby:
A user can select a clip to edit from the set of available raw footage.
A user can review the footage in that fragment.
A user can define an in-point and out-point of the desired clip fragment.
A user can then add the clip to the timeline.
A user can then select a different clip of raw footage to edit onto the timeline and repeat the process.
A user can move fragments on the timeline to different positions on the timeline.
A user can choose an edited clip to reedit by selecting a new in-point and out-point.
A user may also work with a set of audio clips such as soundtrack music and position these audio clips on the timeline. These audio clips may also be compressed and indexed versions of higher quality originals. The user can apply audio effects to these tracks. Examples include, fade in, fade out, and audio gain.

Geographically remote collaborators can view and contribute to the editing decisions in real time. Each collaborator can be assigned roles of varying privileges. While some collaborators will only have privileges to observe the editing decisions, others will be able to actively edit simultaneously. The system can include real-time conferencing abilities to enhance collaborative movie editing. Chat, voice conferencing, video conferencing, whiteboard, file exchange, and desktop sharing abilities will allow co-collaborators to interact in rich real-time experience. The system may feature real-time preview abilities using the edit decision list to render a preview of the final movie by serializing movie clip fragments to the user's computer. In one embodiment, the current invention will feature a graphic representation of a timeline similar to currently available nonlinear editing systems.

In one embodiment, the user can choose between multiple user interface modes. The simplest rough cut mode enables simple editing without a complex menu of transitions and effect. Such a mode is useful to produce a “rough cut” of a movie which can later be refined into the final movie. A basic mode may offer an interface with a limited number of video and audio tracks as well as a limited number of effects and transitions with features similar to Apple iMovie. An expert mode may offer many more options such as multiple video/audio tracks and a diverse menu of effects and transitions including color correcting, compositing, and other special effects tools. The expert mode may include features associated with more feature rich commercial nonlinear editing software such as Apple Final Cut Pro, Premiere Pro, or Avid Xpress Pro.

In one embodiment, a separate special effects mode can facilitate special effects processing featuring characteristics of popular effects software such as Adobe After Effects and Apple Shake.

In one embodiment, the current invention can export a standardized edit decision list or other standard representation of a movie timeline for other nonlinear editing software to import. This software can then render the final movie using the original raw footage clips and the directives in the imported information producing full resolution final output. In one embodiment, the current invention uses uncompressed versions of the original raw footage and may produce full resolution final output of the edited movie.

In some embodiments, the system uses current and pervasive web browser technology, such as browser-embedded video players like QuickTime, Windows Media Player, Real Player, or Macromedia Flash Player. Some embodiments employ HTML, DHTML, JavaScript, HTTP protocols to accomplish the basic editing tasks.

In one embodiment, the current invention uses Macromedia Flash to accomplish enhanced user interface features, such as dragging and dropping representations of video clips on the timeline, and one-click cutting at in-points and out-points. In one embodiment, the current invention uses a custom browser plug-in or java applet designed specifically for editing functionality that allows enhanced rendering and user interface features. In one embodiment, the editing system features a dedicated downloadable application to accomplish editing and communication tasks.

In one embodiment, the current invention allows users to utilize their current commercially available single-user, single-computer nonlinear editing system to edit and allows them to communicate through a special application plug-in. Examples of this type of software includes Apple Final Cut, Apple iMovie, Adobe Premiere, various software from Avid and Pinnacle Systems, Sony Vegas, Adobe After Effects, Apple Shake, Maya 3D, and 3D Studio Max. A special application plug-in allows communication between heterogeneous editing environments through communication using a standardized representation of the Edit decision list, effects sequence, or other representations of a movies timeline. This application plug-in may communicate with collaborating client systems in real-time or delayed time, allowing collaborators to view or contribute to the editing process on the same or different software.

In one embodiment, the current invention allows communication between heterogeneous editing systems including some or all of the previously mentioned embodiments of editing systems.

In one embodiment, client computers of collaborators communicate through a central server or group of servers in a client-server protocol. In another embodiment, collaborators' client applications communicate directly with one another in a manner similar to distributed peer-to-peer application networks such as Gnutella. In yet another embodiment, collaborators' computers communicate through a combination of client-server protocol or group of servers and peer-to-peer protocol.

In one embodiment, edited movies are rendered on a server. Software that contains the correct algorithms to render the frames of the final movie sits on the server and the rendered version of the movie is returned to the client for viewing. In another embodiment, all rendering of movies occurs on the client computer. Software that contains the algorithms for properly rendering frames of the movies is downloaded to the client. In yet another embodiment, some rendering occurs on the client computer while some rendering happens on the server. For example, simple rendering tasks may take place directly on the client's computer while more complex tasks may be offloaded to the server and returned upon rendering.

In some embodiments, the current invention features rich audio editing capabilities similar to current commercially available audio editing software and songs or other audio work is created rather than movies. In some embodiments, the current invention recognizes digitally signed copyrighted work and prevents users from using the work.

Submission of Entries

With further reference to FIG. 1, global participants make movies after receiving requirements. Participants around the world can submit 103 their finished movies though a defined submission process facilitated by the Internet. The submission mechanism collects the finished movie as well as information about the submission and the time of submission. Internet submissions can be made instantly available 104 to the public.

In one embodiment, initial submissions are made in a low bit-rate form over the Internet (to corroborate completion), and subsequently higher quality versions may be sent 107 through traditional means such as by messenger (on physical media such as DVD) or electronically over the Internet (or another network).

Distribution

Embodiments may utilize numerous possible modes of short-film distribution. Possible distribution avenues include television, the Internet, distributed public screenings, and physical media.

The invention is well-suited to television distribution 110. Television distribution may include profiles of participants, documentaries of their filmmaking experience, as well as the final movie products of the event. A television series can profile a series of events that allow for an elimination competitive format.

Regarding Internet distribution, viewers 109 can access movies directly on personal computers almost immediately after they are submitted. Technologies such as video streaming, using formats such as QuickTime, may be used to this end. It will be appreciated that alternative electronic communication networks can be used.

Screenings 108 can be conducted publicly for gatherings of viewers shortly after movies are submitted. High quality compressed video is downloaded through the Internet for large screen, public screenings distributed around the world. Depending on the format of a specific event, some or all movies may be available for screening in any location. For example, if the start of the event is staggered geographically by time zone, an event in any time zone will only have access to completed movies from earlier time zones

After the event, physical media such as high quality DVDs can be distributed to home viewers and later screening events 110. This physical media may be a highly produced combination of documentary-style footage covering the moviemaking process and the short-films produced themselves.

Preferably, for enhanced viewer experience and immediacy, selected ones of the received films are screened relatively quickly after the end time of a moviemaking event. In various embodiments, the screening takes place no more than 72 hours, 48 hours, 24 hours, 10 hours, 5 hours, 2 hours, 1 hour, 10 minutes, 1 minute, or 10 seconds after the end time.

Embodiments of the invention may include a feature-rich audience experience. In other words, Internet users can have continuous access to a comprehensive catalogue of submitted films, and the viewing experience can be enhanced by a number of features of the user interface.

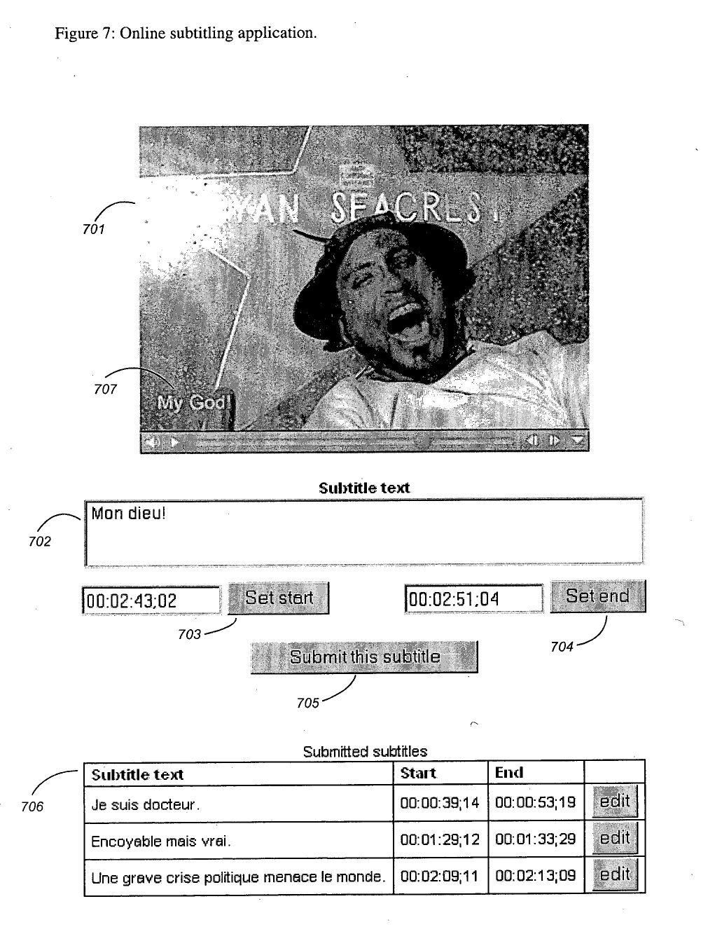

FIG. 7 illustrates an example of a Web-based subtitle creation utility. The system preferably allows Internet users to contribute foreign language subtitles to a movie through a web interface. Upon viewing a movie, a user may optionally choose to add subtitles. For example, a viewer who speaks both English and French may choose to add French subtitles to a movie originally made in English for the benefit of future French viewers who do not speak English.

An Internet user can accomplish this through a simple web interface (although non-Web interfaces are also possible). First, the user selects the option to contribute subtitles to a movie. The system then allows the user to view a web version of the movie within a page that contains a number of video inputs 701. By activating a control element 703 (illustrated as a mouse-clickable button icon), the user can pause the movie and select a specific movie frame for the start point of the subtitle. The user can also activate a control element 704 to select a later frame for endpoint of a subtitle in the movie. The user can also input the subtitle text 702. Upon submission of this information (e.g., by activating a submission control element 705), the system records this text as well as the exact time codes of the start and end of the subtitle. The user reiterates this process for all necessary subtitles in the movie. A summary list 706 of submitted subtitles may appear on the web page for easy tracking.

The system can then compile the movie for playback with subtitles. Future viewers can view a subtitled version of the movie if a previous user has contributed subtitles 707. Movies may be rendered with subtitles prior to viewing or in real time during presentation. The subtitle information gathered through this web interface can subsequently be used to create subtitled versions of the movie in other media for distribution such as DVD, cinema, or television.

A number of technologies make adding subtitles to a movie through a web interface possible. Embedded players such as Apple QuickTime, Windows Media Player, Macromedia Flash, and Real Player can play movies within a web browser. Information about current time code can be obtained from the player through existing protocols such as the JavaScript programming language. Communication between the web browser and server can pass along the information needed to add subtitles to the server. The server can record this information. Server-side technology can automate the rendering of movies with subtitles on the server-side. Existing technology exists to automate and control the re-rendering of movies with subtitles can exist on the server. For example, AVIsynth (http://www.avisynth.org) features both a scripting language and the ability to specify subtitles.

Alternatively, subtitle information recorded on the server may be passed to the viewer's system to be rendered on the client computer. For example, Macromedia flash may be used to render the subtitles on a layer in front of a non-subtitled flash movie. While the layer containing the non-subtitled movie remains constant, a layer in front of the non-subtitled movie may be used to present the text of the subtitles. Scripting languages such as Macromedia Flash ActionScript and client server Internet communications protocols can be used to automate the rendering of the movie depending on selected user preferences (such as language).

The current invention preferably involves the creation of linked and searchable profiles that help website users find material they may find informative, educational, or entertaining. Individuals, teams, movies, locations, and event dates have profiles. These profiles can be rendered as web pages and hyperlinked based on relationships. For example, each team profile may link with its team members' profiles as well as the movies, locations, and events associated with that team. A viewer who finds one movie interesting may follow links to other movies by the same team, individual contributor, or other movies for that location or event. Some or all of the movies by one particular individual, team, location, or event date may be retrieved. The audience can seek material by traversing the network of participants, movies, teams, locations, and event dates. The audience may also search these profiles based on criteria on a variety of profile properties.

In an embodiment, users of the online system have personal profiles. These personal profiles may contain information about the user, and the user may optionally make some or all of this information public. The system may also complement the user-created profile by tracking and compiling user preferences in movies. The system may make recommendations to the users depending on the behavior and preferences of other similar users. In some embodiments users can also create public lists of favorite works. For example, a user may create a list of favorite 10 movies available on the system or a list of 12 favorite comedies. Other users may view these lists, and the lists may be suggested to users based on preferences and behavior.

In one embodiment, some or all audience members may be required to login, so that they may have an identity from the perspective of the system (to store user preference information) as well as from the perspective of other audience members, so that they may share information in a non-anonymous fashion.

In an embodiment, audience members may subscribe to fan lists. Fan lists help teams, individuals, organizers, and other creators communicate with their audience. Any website user may subscribe to the fan list of a movie, team, team member, event location, or other groups or individuals in the system. Users may subscribe to a fan list through a link on the web page profiling a movie, team, individual, location, or event date. Users may unsubscribe to that fan list at any time through a web interface.

In an embodiment, entities can then contact people on their respective fan lists to announce the availability of new creative works within or outside of the current system. In an embodiment, the system may automatically contact members of a fan list when a new creative work is available related to that fan list. For example, when a new movie is available, the system may automatically contact the fan list of the team that created the movie to announce its availability. System administrators may also contact fan lists to make special announcements. In some embodiments, the current invention may allow a user to see another user's list of fan list subscriptions.

In some embodiments, audience members may recommend content to their friends, by emailing links directly from the website. These links would allow outside users a direct manner of which to reach the site and could automate or partially automate the sign up process for a new audience member.

In addition to the advantage of instant access to newly made movies, home Internet distribution allows viewers to rate and comment on the movies they watch. These ratings and comments can then be made available to subsequent users of the system. In fact, ratings may be aggregated and the audience may be shown movies based on this aggregation. In other words, the system can help select the most entertaining submissions for viewing. Further, the rating system provides valuable feedback to participants on the quality of their product.

In some embodiments, not only can other viewers view rating statistics and read comments, they can search for and sort movies based on many factors, including ratings and popularity, filmmaker, actor, or other team member, genre, date, ingredients, geographic origin, and other viewers' suggestions.

In some embodiments, the system automatically generates lists of the “best movies” based on ratings and popularity so that an audience member can view the top films (those others have attested to as being of high quality) without having to sift through the entire corpus of entries.

In some embodiments, the system can suggest other movies to a user based on the user's rating behavior. This suggestion can be based on the analysis of behavior of other similar users. Users will have profiles that record their preferences and behaviors. By comparing these preferences and behaviors to other users, the system can suggest movies that the user will like.

In some embodiments, prizes are awarded to selected teams. These prizes may be awarded according to a number of criteria including jury selection (i.e., decision of a jury, described below) and audience voting. Also, teams may receive compensation for contributing content to the website. In one embodiment, contributed content is compensated with payment depending on number of views of their movie, user rating, or combination of factors.

In some embodiments, banner advertising and sponsored links are displayed to users. This material could be targeted based on the associated content, geography, user preferences, or other related information. In an embodiment, advertisers may display advertisements at the physical kick-off and screening locations and on the website.

The system can include an e-commerce interface to allow users to purchase physical media (e.g., DVDs) containing footage of the events, the participants' film entries, and/or of independent films. Merchandising of company products such as t-shirts may also be provided using e-commerce.

Administrator Interface

Embodiments may contain an administrator interface allowing for regulation of content to conform to standards of acceptability. Further, it can be used to customize the look and feel of the system. In an embodiment, it may allow editing of audience-generated comments and ratings.

In an embodiment, the administrator interface allows detailed statistical analysis and reports reflecting participant and audience information.

Competition

The current invention can have both competitive and noncompetitive embodiments. In a noncompetitive embodiment, participants create and submit movies for screening, and movies are not judged or rated in any category. This embodiment may be appropriate for certain groups such as youth or inexperienced moviemakers.

With regard to competitive embodiments of the invention, several different aspects merit discussion, including juries, audience awards, and long term competitions:

In some embodiments, movies are judged by a judge or panel of judges (jury) on a number of categories such as best overall, best cinematography, best use of prescribed ingredient, best comedy, or best sound design. Submissions can be ranked in each category and can receive cash, merchandise, filmmaking gear or other prizes such as a movie distribution deals. For example, high-ranking submissions can win participants guaranteed slots in future screenings.

In other embodiments, the audience votes on best movies in one or more categories. This voting can occur at a physical public screening location, through the Internet, through phone networks (e.g., cellular networks, text messaging, etc.), or other communication channels. Submissions are ranked and receive prizes similar to those mentioned in the jury discussion above. These rankings can be combined with a jury embodiment to produce composite scores reflecting both judge and audience opinions.

With regard to long-term competitions, participating teams and individuals can participate in an ongoing competition that lasts over time. In one embodiment, teams may hold a relative rank based on past performance. Teams can compete to improve their standing in this cumulative rank overall or in a number of categories. Likewise, individual filmmakers and actors may be ranked based on their past performance regardless of their team membership. All ranking criteria can come from both juried or audience generated judgment, or from a combination thereof.

In another embodiment, a number of teams may participate in an elimination series. During or after each event, one or more teams may be eliminated from competition leaving one final victor at the end of the series. In addition, the competition may acquire competitors during the series based on selection criteria. However, the series will progress as more teams are eliminated than acquired, finally leaving one winning team.

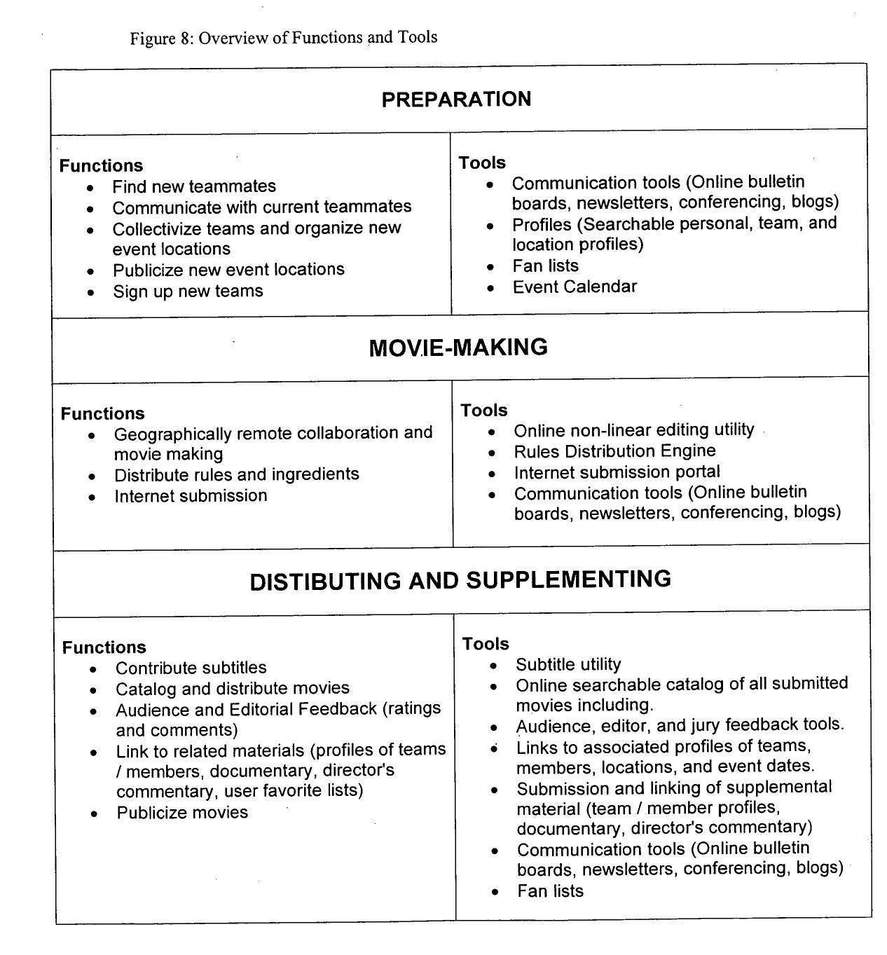

FIG. 8 is a chart describing functions and tools, without limitation, that are facilitated and provided by embodiments of the present invention.

In the claims set forth below, the term “film” refers to any form of motion picture, including without limitation videotape formats, digital video files, conventional film, and the like.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein.

What is claimed is:

1. A method of conducting a filmmaking event, comprising:
providing a set of rules to a plurality of entities, each entity comprising an individual or a team of individuals, some of the entities in different cities, states or countries;
receiving over an electronic network movies created by the entities in conformity with said rules in a specified period of time; and
distributing said received movies over said electronic network.

2. The method of claim 1, wherein the rules include a requirement that a film must contain a complete set of film ingredients.

3. The method of claim 1, further comprising publicly screening some of the received movies at geographically dispersed locations, no more than 24 hours after said step of receiving the movies.

4. The method of claim 1, wherein said step of receiving the movies occurs no more than 10 hours after said step of providing the rules to the entities.

5. The method of claim 2, further comprising publicly screening some of the received movies at geographically dispersed locations, no more than 24 hours after said step of receiving the movies.

6. The method of claim 2, wherein said step of receiving the movies occurs no more than 10 hours after the film ingredients are provided to the entities.

7. The method of claim 1, wherein providing the rules comprises using a configurable rules distribution engine to provide the rules to at least two entities located in different time zones, the rules distribution engine providing the rules at a particular time of day in each of the two entity's local time zone.

8. The method of claim 2, wherein providing the rules comprises using a configurable rules distribution engine to provide the film ingredients to at least two entities located in different time zones, the rules distribution engine providing the ingredients at a particular time of day in each of the two entity's local time zone.

9. The method of claim 1, further comprising making resources available to the entities over said network to facilitate moviemaking.

10. The method of claim 9, wherein the resources include audio and video clips that the entities may incorporate into their movies royalty-free.

11. The method of claim 9, wherein the resources include software tools for online collaborative film-editing.

12. The method of claim 9, wherein the resources include a web-based subtitle creation utility.

13. A method of conducting a filmmaking event, comprising:
communicating a start time and an end time to a plurality of geographically dispersed filmmaking entities, each of the entities comprising an individual or a team of individuals, the end time being no later than 48 hours after the start time;
giving a set of film rules at or after the start time to each of the entities;
receiving films before the end time from at least some of the entities, wherein at least some of the received films meet all of the film rules; and
presenting some of the received films over an electronic communications network to a plurality of geographically dispersed audience members.

14. The method of claim 13, wherein presenting some of the received films comprises presenting some of the received films over the electronic communications network within one hour of said step of receiving the films.

15. The method of claim 13, wherein presenting some of the received films comprises presenting some of the received films over the electronic communications network within 30 minutes of said step of receiving the films.

16. The method of claim 13, wherein giving the film rules comprises giving the set of film rules at a community-initiated local event.

17. The method of claim 13, further comprising screening at least some of the received films as part of a community-initiated local event.

18. A method of conducting a filmmaking event, comprising:
communicating a start time and an end time to a set of filmmaking entities, each of the entities comprising an individual or a team of individuals, the end time being less than 48 hours after the start time;
giving a set of film rules at or after the start time to each of the entities;
receiving films before the end time from at least some of the entities, wherein at least some of the received films meet all of the film rules;
presenting selected ones of the received films to audience members; and
receiving through an electronic communications network quality ratings for one or more of the presented films from the audience members.

19. The method of claim 18, wherein the quality ratings comprise numerical scores.

20. The method of claim 19, further comprising, for one or more of the films, electronically transmitting to one or more individuals an average of the numerical scores received for the film.

21. The method of claim 20, wherein said average is presented on a web site.

22. The method of claim 21, further comprising ranking a plurality of the films based on the films' averages.

23. The method of claim 18, wherein the quality ratings comprise ratings for the overall quality of the films.

24. The method of claim 18, wherein the quality ratings comprise ratings for the cinematography of the films.

25. The method of claim 18, wherein the film rules require a set of film ingredients to be in a film, the quality ratings comprising ratings for the use of the film ingredients.

26. The method of claim 18, wherein the quality ratings comprise ratings for the sound design of the films.

27. The method of claim 18, wherein the audience members comprise a panel of film experts.

28. The method of claim 18, further comprising presenting a list of the highest rated of the received films.

29. The method of claim 28, wherein the list is presented on an Internet web site.

30. A method of conducting a filmmaking event, comprising:
communicating a start time and an end time to a set of filmmaking entities, each of the entities comprising an individual or a team of individuals, the end time being no later than 48 hours after the start time;
giving a set of film rules at or after the start time to each of the entities;
receiving films before the end time from at least some of the entities, wherein at least some of the received films meet all of the film rules;
storing selected ones of the received films in an electronic storage;
providing access to the selected ones of the received films over an electronic communication network; and
providing an automated system configured to:
receive a textual search query through the electronic network from a remotely located individual;
search the storage for films having content that relates to the search query; and
if one or more films are found that relate to the search query, transmit said one or more related films or information regarding said related films to the remotely located individual through the electronic network.

31. The method of claim 30, further comprising encoding the films that are stored in the electronic storage so that they can be matched to a textual search query.

32. The method of claim 30, further comprising:
receiving a textual search query through the electronic network, the search query containing a name of an actor; and
searching the storage for films having footage of the actor.

33. A method of conducting a filmmaking event, comprising:
communicating a start time and an end time to a set of filmmaking entities, each of the entities comprising an individual or a team of individuals, the end time being no more than 48 hours after the start time;
giving a set of film rules at or after the start time to each of the entities;
obtaining footage of at least one of the entities as said at least one entity attempts to create a film conforming to the film rules;
receiving films before the end time from at least some of the entities, wherein at least some of the received films meet all of the film rules; and
creating a film interweaving said footage with selected portions of the films received from the entities.

34. A method of conducting a global filmmaking event, comprising:
communicating a start time and an end time to a set of filmmaking entities, each of the entities comprising an individual or a team of individuals, the end time being no more than 48 hours after the start time;
giving a set of film rules at or after the start time to each of the entities;
providing the entities with access to filmmaking resources through an electronic communication network, the filmmaking resources comprising one or more of video clips available for insertion into a film, music clips available for use in a film, filmmaking tips and guidelines, a web-based subtitle creation utility, and contact information for individuals available for joining and assisting one of the entities in creating a film; and
receiving films before the end time from at least some of the entities, wherein at least some of the received films meet all of the film rules.

35. The method of claim 34, wherein the electronic communication network comprises the Internet and the filmmaking resources are presented on a web site.

36. The method of claim 34, wherein said start time comprises a first start time and said end time comprises a first end time, the method further comprising:
communicating a second start time and a second end time to a second set of filmmaking entities, each of the second set of entities comprising an individual or a team of individuals, the second start time following the first start time by a first temporal interval, the second start time preceding the first end time, the second end time following the first end time by the first temporal interval;
electronically transmitting a set of film rules at or after the second start time to the second set of entities; and
receiving films before the second end time from at least some of the second set of entities, wherein at least some of the received films from the second set of entities meet all of the film rules.

37. The method of claim 36, further comprising:
communicating a third start time and a third end time to a third set of filmmaking entities, each of the third set of entities comprising an individual or a team of individuals, the third start time following the second start time by a second temporal interval, the third start time preceding the first end time, the third end time following the second end time by the second temporal interval;
electronically transmitting the set of film rules at or after the third start time to the third set of entities; and
receiving films before the third end time from at least some of the third set of entities, wherein at least some of the received films from the third set of entities meet all of the film rules.
